(19) United States
(12) Patent Application Publication
(10) Pub. No.: US 2022/0415119 A1
(43) Pub. Date: Dec. 29, 2022

(54) GAME MONITORING

(71) Applicant: SENSETIME INTERNATIONAL PTE. LTD., Singapore (SG)

(72) Inventors: Fei XIE, Singapore (SG); Xinxin WANG, Singapore (SG); Liyao YANG, Singapore (SG)

(21) Appl. No.: 17/363,974

(22) Filed: Jun. 30, 2021

Related U.S. Application Data
(63) Continuation of application No. PCT/IB2021/055743, filed on Jun. 28, 2021.

(30) Foreign Application Priority Data
Jun. 24, 2021 (SG) 10202106954Y

(51) Int. Cl. G07F 17/32; G06K 9/00; G06K 9/20; G06K 9/70

(52) U.S. Cl. CPC G07F 17/322; G06K 9/00718; G06K 9/2054; G06K 9/70; G06K 9/00671; G07F 17/3293

(57) ABSTRACT

The present disclosure provides a game monitoring method, a game monitoring apparatus, a device and computer-readable storage medium. An image or video collection for a game area is performed, a state of a designated object within the game area is determined based on at least one collected frame, and a detection for the game area is stopped in response to determining that the designated object is in a first state and resumed in response to determining that the designated object is switched from the first state to a second state. Through the above solution, scenarios in which a game host performs some specific operations on the designated object, e.g. a game prop withdrawing device, can be identified automatically based on an image or video of the game area, and the detection for a game area can be stopped or resumed when these scenarios begin or end, which achieves monitoring the game more intelligently.

### CROSS-REFERENCE TO RELATED APPLICATION

The present disclosure is a continuation application of PCT Application No. PCT/IB2021/055743 filed on Jun. 28, 2021, which claims priority to Singapore Patent Application No. 10202106954Y filed on Jun. 24, 2021, the entire contents of which are incorporated herein by reference in their entireties.

### TECHNICAL FIELD

The present disclosure relates to the field of video monitoring technologies, and in particular to a game monitoring method, a game monitoring apparatus, a device and computer-readable storage medium.

### BACKGROUND

With the development of technology, higher intelligence has been required in more scenarios. Taking a game scenario as an example, behaviors of a game host generally are expected to comply with game rules in a game process, and at the same time, a game result may be determined based on performances of the player in the game process, for example, a calculated score and the like. Thus, it is necessary to monitor the behaviors of the game host in the game process to determine whether an abnormal behavior occurs in the game process, calculate a game result, etc. At present, in most game scenarios, it depends on a user of a monitor system to manually achieve monitoring the behaviors of the game host in the game process, which leads to a low intelligent degree. Therefore, it is expected to provide an intelligent solution capable of monitoring the game process automatically and accurately.

### SUMMARY

The present disclosure provides a game monitoring method, a game monitoring apparatus, a device and computer-readable storage medium.

According to a first aspect of the examples of the present disclosure, provided is a game monitoring method, including:

performing an image or video collection for a game area;

determining a state of a designated object within the game area based on at least one collected frame;

in response to determining that the designated object is in a first state, stopping a detection for the game area; and

in response to determining that the designated object is switched from the first state to a second state, resuming the detection for the game area.

In some examples, the determining the state of the designated object within the game area based on the at least one collected frame includes:

recognizing whether the designated object has a first feature based on the at least one collected frame, and if yes, determining that the designated object is in the first state; or

recognizing whether the designated object has a second feature based on the at least one collected frame, and if yes, determining that the designated object is in the second state.

In some examples, the at least one collected frame includes a plurality of collected frames:

where the determining the state of the designated object based on the at least one collected frame includes:

in response to determining that the designated object in a certain collected frame has the first feature, recognizing whether the first feature changes in a next frame, and if yes, clearing a first counter, otherwise incrementing the first counter by 1; and in response to determining that a value of the first counter reaches a first counting threshold, determining that the designated object is in the first state; or

in response to determining that the designated object in a certain collected frame has the second feature, recognizing whether the second feature changes in a next frame, and if yes, clearing a second counter, otherwise incrementing the second counter by 1; and in response to determining that a value of the second counter reaches a second counting threshold, determining that the designated object is in the second state.

In some examples, the method further includes:

determining a coverage ratio of an operating component with respect to all or a part of the designated object, where the operating component is configured to operate the designated object; and

in response to determining that the coverage ratio is less than a preset threshold, determining that the designated object with the first feature is in the first state, or the designated object with the second feature is in the second state.

In some examples, the determining the coverage ratio of the operating component with respect to all or the part of the designated object includes:

determining a first detection box corresponding to all or the part of the designated object;

determining a second detection box corresponding to the operating component; and

determining the coverage ratio of the operating component with respect to all or the part of the designated object based on a coverage ratio of the second detection box with respect to the first detection box.

In some examples, the determining the coverage ratio of the operating component with respect to the part of the designated object includes:

determining a coverage ratio of the operating component with respect to a cover of a game prop withdrawing device.

In some examples, the designated object includes at least a game prop withdrawing device;

where the first feature includes that: a cover of the game prop withdrawing device is open; or

where the second feature includes that: the cover of the game prop withdrawing device is closed.

In some examples, the designated object further includes a mark part for fixing game props in the game prop withdrawing device;

where the first feature further includes that: the mark part is placed in a preset manner; or

where the second feature further includes that: the mark part is not detected within the game area.

In some examples, the recognizing whether the designated object has the first feature include: in response to recognizing that the cover of the game prop withdrawing device is open, recognizing whether the mark part is placed in the preset manner.

In some examples, the recognizing whether the designated object has the second feature include: in response to recognizing that the cover of the game prop withdrawing device is closed, recognizing whether the mark part is not detected within the game area.

In some examples, the preset manner includes that: the mark part is placed a designated side outside the game prop withdrawing device.

In some examples, the method further includes:

in response to determining for a first time that the designated object is in the first state, recording and/or prompting corresponding first time information; or

in response to determining that the designated object is switched from the first state to the second state, recording and/or prompting corresponding second time information.

In some examples, the method further includes:

in response to determining that a game enters a target stage, determining the state of the designated object based on the at least one collected frame.

In some examples, the method further includes.

in response to detecting that a number of game props within the game area is 0, determining that the game enters the target stage.

In some examples, the method further includes:

in response to detecting that the designated object meets a preset warning condition, sending out a warning message.

According to a second aspect of the examples of the present disclosure, provided is an electronic device. The electronic device includes at least one processor; and one or more memories coupled to the at least one processor and storing programming instructions for execution by the at least one processor to implement the method mentioned in the above first aspect.

According to a third aspect of the examples of the present disclosure, provided is a non-transitory computer-readable storage medium coupled to at least one processor and storing programming instructions for execution by the at least one processor to implement the method mentioned in the above first aspect.

In the examples of the present disclosure, by performing an image or video collection for a game area, determining a state of a designated object, e.g., a game prop withdrawing device, based on at least one collected frame, and then determining whether specific scenarios in which a detection for the game area is expected to be stopped are introduced, it achieves stopping or resuming the detection for the game area. Through the above solution, the scenarios in which a game host performs some specific operations on the designated object, e.g., the game prop withdrawing device, can be identified automatically based on an image or video of the game area, and the detection for the game area can be stopped or resumed when these scenarios begin or end, which achieves monitoring the game more intelligently.

It should be understood that the above general descriptions and the subsequent detailed descriptions are merely illustrative and explanatory and shall not be intended to limit the present disclosure.

### BRIEF DESCRIPTION OF THE DRAWINGS

The accompanying drawings, which are incorporated in and constitute a part of the present description, illustrate examples consistent with the present disclosure and serve to explain the principles of the present disclosure together with the description.

FIG. 1 is a schematic diagram of monitoring a card game automatically according to one or more examples of the present disclosure.

FIG. 2 is a schematic diagram illustrating an application scenario according to one or more examples of the present disclosure.

FIG. 3 is a flowchart illustrating a game monitoring method according to one or more examples of the present disclosure.

FIG. 4 is a schematic diagram of determining a coverage ratio of an operating component with respect to a game prop withdrawing device according to one or more examples of the present disclosure.

FIG. 5 is a schematic diagram illustrating a Baccarat game in a game hall according to one or more examples of the present disclosure.

FIG. 6 is a schematic diagram illustrating a logic structure of a game monitoring apparatus according to one or more examples of the present disclosure.

FIG. 7 is a schematic diagram illustrating a logic structure of an electronic device according to one or more examples of the present disclosure.

### DETAILED DESCRIPTION OF THE EMBODIMENTS

Examples will be described in detail herein, with the illustrations thereof represented in the drawings. When the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

The terms used in the present disclosure are for the purpose of describing a particular example only, and not intended to be limiting of the present disclosure. The singular forms such as “a”. “said”, and “the” used in the present disclosure and the appended claims are also intended to include multiple, unless the context clearly indicates otherwise. It is also to be understood that the term “and/or” as used herein refers to any or all possible combinations that include one or more associated listed items. Further, the term “at least one” herein represents any one of multiple or any combination of at least two of multiple.

It is to be understood that although different information may be described using the terms such as first, second, third, etc. in the present disclosure, these information should not be limited to these terms. These terms are used only to distinguish the same type of information from each other. For example, the first information may also be referred to as the second information without departing from the scope of the present disclosure, and similarly, the second information may also be referred to as the first information. Depending on the context, the word “if” as used herein may be interpreted as “when” or “as” or “determining in response to”.

In order to help those skilled in the art to better understand the technical solutions of the examples of the present disclosure and make the above objects, advantages and features of the examples of the present disclosure clearer and more understandable, the technical solutions of the examples of the present disclosure will be further detailed below in combination with the accompanying drawings.

With the development of technology, higher intelligence has been required in more scenarios. Taking a game scenario as an example, it is generally necessary to monitor the behaviors of a game host in a game process to determine whether an abnormal behavior occurs in the game process, calculate a game result, etc. At present, in most game scenarios, it depends on a user of a monitor system to manually achieve monitoring the behaviors of the game host in the game process, which leads to tedious procedures and a low intelligent degree.

To make a game more intelligent, a device for automatically monitor the game can be adopted, so as to find any abnormality in a game process in time and automatically output a game result based on the monitoring. For example, videos or images of a game area may be collected and analyzed to determine whether there is any abnormal behavior in the game process, and determine the game result through analyzing the videos or images. FIG. 1 illustrates a scenario diagram in which a card game is automatically monitored. One or more collection devices 12 may be disposed near a game area 11 (for example, above or at both sides of the game area) to collect images or videos for a game table and surrounding region thereof and then send the images or videos to a service system 13 for detecting the game. The service system 13 may analyze a current stage of the game based on the images or videos, for example, a card dealing stage, a card playing stage or a scoring stage according to game host operations, number or point of cards on the game table and the like, and execute a detection logic consistent with the stage. One game host interaction device 14 may be disposed near the game area 11 in communication with the service system 13. The processing results of the service system 13 in various stages of the game may be output to the game host through an interaction interface of the game host interaction device 14. For example, when the game is in a card dealing stage or a card playing stage, if it is detected that a game host deals or plays cards in violation of a game rule, an abnormality prompt may be sent out through the interaction interface of the game host interaction device 14. A calculated score of each player may be output to the game host for displaying through the interaction interface of the game host interaction device 14.

There may be some specific scenario, similar to the above scenario in which monitoring a game is automatically performed. In such scenario, since the service system automatically identifies the current stage of the game within the game area and detects the game based on a detection logic corresponding to the stage, detection for the game area may be interrupted temporarily to perform some specific operations for the game area. For example, game props are usually used in a game process and are housed in a game prop withdrawing device within the game area. When all game props in the game prop withdrawing device are dispensed, the game prop withdrawing device has to be reloaded in time. For example, taking a card game as an example, when all cards in a card box are dispensed, new cards have to be replenished into the card box in time. At this time, it is required to temporarily suspend the game, and the service system has also to stop the detection for the game area by preset detection logic, so as to avoid frequent error alarms. Therefore, it is expected to automatically identify some specific scenarios in which the detection for the game area is to be paused in a game process, and stop or resume the detection for the game area based on the beginning and ending of these scenarios, thereby reducing manual operations of users of a monitor system, which achieves monitoring the game more intelligently.

Based on this, the examples of the present disclosure provide a game monitoring method, with taking a game prop withdrawing device as example. Through this method, a state of the game prop withdrawing device within a game area can be automatically detected based on an image or video of the game area, and whether there is a specific scenario in which detection for the game area is to be paused is determined based on the state of the game prop withdrawing device, so as to stop or resume the detection for the game area.

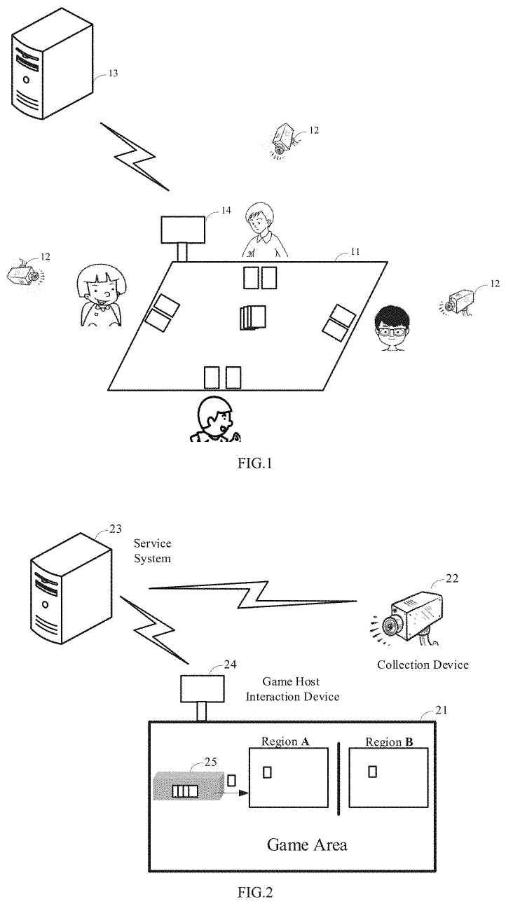

FIG. 2 is a schematic diagram illustrating an application scenario according to one or more examples of the present disclosure. It should be noted that FIG. 2 only illustrates an illustrative example provided for explaining the method according to the examples of the present disclosure and the examples of the present disclosure are not limited to the scenario shown in FIG. 2. FIG. 2 illustrates a schematic diagram of a game scenario. One or more collection devices 22 may be disposed near a game area 21 (e.g., a game table) to collect images or videos for the game area 21, and then send the collected images or videos to a service system 23. The service system 23 may communicate with the collection devices 22 in a wired or wireless manner. The service system 23 may detect the images or videos and determine whether there is any abnormality in a game process based on a detection result. When detecting that there is an abnormality in the game process, the service system 23 may send out abnormality prompt information through a game host interaction device 24 within the game area to prompt the game host about the abnormality. The game area 21 may further include a game prop withdrawing device 25 (e.g., a card box) for housing game props (e.g., cards) used in the game process. In the game process, the game host may take the game props from the game prop withdrawing device 25 and dispense the game props to designated regions (e.g., region A and region B) within the game area in a predetermined sequence. Generally, the game host may perform some specific operations for the game prop withdrawing device 25. When performing these operations, the game has to be interrupted. For example, the game host needs to replenish the game props into the game prop withdrawing device 25. The game prop withdrawing device 25 may be a device with a cover. Based on various features, such as that the cover of the game prop withdrawing device 25 is open or closed, it is determined whether the game host is adding the game props into the game prop withdrawing device 25, and thus whether to stop or resume the detection for the game area is determined.

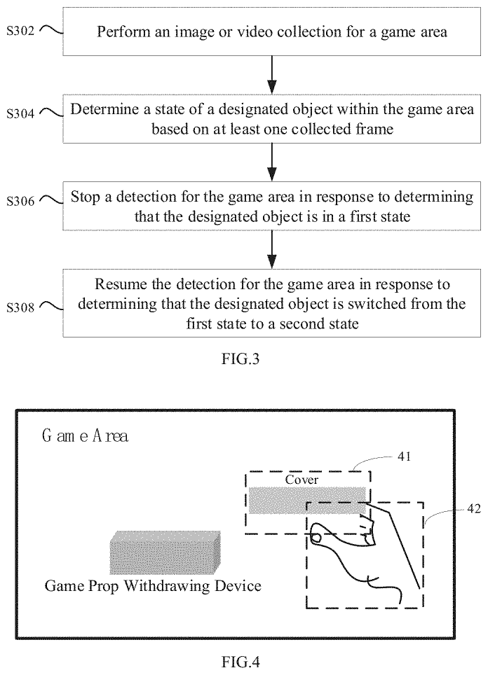

Specifically, as illustrated in FIG. 3, a game monitoring method according to one or more examples of the present disclosure includes the following steps.

At step S302, an image or video collection for a game area is performed.

At step S304, a state of a designated object within the game area is determined based on at least one collected frame.

At step S306, a detection for the game area is stopped in response to determining that the designated object is in a first state.

At step S308, the detection for the game area is resumed in response to determining that the designated object is switched from the first state to a second state.

The game monitoring method in the examples of the present disclosure may be performed by a specified service system. The service system may be a mobile phone, a laptop computer, a server, a server cluster and the like, which is not limited herein.

When the designated object of the examples of the present disclosure is operated, the game process may be interrupted. At this time, if the original detection logic is kept in the service system, it will cause frequent error alarms. For example, the designated object may be a game prop withdrawing device, the game host has to wait and the game process is paused when the game props are put in. For another example, the designated object may be a specific signal generator, and when it is activated to deal with emergencies on the game table, the game process has to be paused. The present disclosure does not limit the type of the designated object.

The game area of the present disclosure is monitored by the service system. In some examples, it is possible to determine whether to stop or resume the detection for the game area by detecting the state of the designated object. For example, when the loading of the game props is completed, the recognition of the state of the designated object is initiated through a specific trigger signal. Alternatively, in some examples, the game area may be divided into a plurality of sub-areas, and the designated object is set in a first sub-area. The detection for the first sub-area may always be maintained, and according to the determined state of the designated object, whether to stop or resume the detection for other sub-areas except the first sub-area within the game area is determined.

The designated object may be the game prop withdrawing device for housing game props. The game props in the examples of the present disclosure may be various props used in the game process, for example, cards, game coins, tokens, dices, and the like. The game prop withdrawing device may be of various apparatuses used to house the game props. In the game process, a game host may obtain a game prop from the game prop withdrawing device. For example, in some examples, the game within the game area may be a card game, the game props may be the cards, and the game prop withdrawing device may be a card box for housing the cards. In some scenarios, except to house the cards, the card box may also be used to perform operations such as card shuffling, card dealing and the like.

Generally, the game process usually includes a plurality of game stages. Taking the game prop withdrawing device as the designated object as example, a specific operation performed by the game host for the game prop withdrawing device, for example, the operation of adding the game props, is usually performed in a specified stage of the game. Therefore, in the step S304, the current stage of the game may be firstly determined based on one or more collected images or videos of the game area, and the state of the game prop withdrawing device within the game area is detected based on the one or more image or video frames of the game area in response to determining that the game is currently in a target stage. Then, whether the game host is performing some specific operations on the game prop withdrawing device is determined based on the state of the game prop withdrawing device.

In the step S306, in response to determining that the game prop withdrawing device is in the first state, a detection state parameter in the service system (or a detecting module thereof) may be set to a first parameter to stop the detection for events and/or objects within the game area. The first state may correspond to a feature presented by the game prop withdrawing device when a game host performs a specific operation on the game prop withdrawing device, for example, a feature that the cover of the game prop withdrawing device is open, closed, in a fixed pose, or the like, which may be set according to actual situations. When the game prop withdrawing device has the first feature, for example, the cover is open, it is expected to stop the detection for the events and/or objects within the game area. For each stage of the game, the service system (or the detecting module thereof) is in-built with a detection logic corresponding to the stage in advance. The detection for the game area may be performed based on the detection logic, for example, performing the detection for some events or some objects within the game area. The event may be of various events that a game host operates on a game prop, and the object may be a game host, a game prop, or the like. When the game host performs a specific operation on the game prop withdrawing device, the detection for the game area may be stopped to avoid frequent error alarms caused by continuing detecting the game area based on the original detection logic. In addition, the detection for the game area may be stopped or resumed by setting the detection state parameter in the service system (or the detecting module thereof). For example, the detection state parameter in the service system (or the detecting module thereof) may be set to the first parameter to stop the detection for the game area.

In the step S308, in response to determining that the game prop withdrawing device is switched from the first state to the second state, the detection state parameter in service system (or the detecting module thereof) is set to the second parameter to resume the detection for the events and/or objects within the game area. When the game host completes a specific operation on the game prop withdrawing device, the game prop withdrawing device will be resumed to a normal game state, i.e., the game prop withdrawing device has the second feature that, for example, the cover is closed. At this time, if it is determined that the game is switched from the first state to the second state based on the images or videos of the game area, the detection state parameter in the service system (or the detecting module thereof) is set to the second parameter to resume detection for the game area. For example, the detection state parameter in the service system (or the detecting module thereof) may include 1 and 0. When the detection state parameter is set to 0, the service system (or the detecting module thereof) will stop the detection for the game area; and when the detection state parameter is set to 1, the detection for the game area will be resumed.

In some examples, the designated object may further include a mark part for fixing the game props in the game prop withdrawing device. Generally, when the game host adds the game props into the game prop withdrawing device, the operations usually include: opening the cover of the game prop withdrawing device, taking out the mark part for fixing the game props, placing the game props into the game prop withdrawing device, and then placing the mark part into the game prop withdrawing device to fix the game props. Thus, when the game host adds one or more game props, the cover of the game prop withdrawing device is open and the mark part is taken out from the game prop withdrawing device. When the game host completes the load of the game props, the cover of the game prop withdrawing device is closed, and the mark part is placed in the game prop withdrawing device and thus will not be detected. As a result, in some examples, when the state of the designated object within the game area is determined based on one or more images or videos of the game area, if it is recognized based on the images or videos of the game area that the cover of the game prop withdrawing device is open and the mark part is placed outside the game prop withdrawing device in a preset manner, it is determined that the designated object is in the first state. If it is recognized based on the images or videos of the game area that the cover of the game prop withdrawing device is closed and the mark part is not detected within the game area, it is determined that the designated object is in the second state. Before adding the one or more game props into the game prop withdrawing device, the game host may take out the mark part from the game prop withdrawing device, and then place the mark part outside the game prop withdrawing device in the preset manner, for example, in a preset position in a preset pose. It is possible to simultaneously recognize whether the cover of the game prop withdrawing device is open/closed and whether the status of the mark part complies with a preset condition, so as to determine whether it is in a scenario where the game host is adding the one or more game props. In this way, the scenario can be accurately identified and the operations of the service system (or the detecting module thereof) can be controlled. Alternatively, it is possible to recognize whether the mark part is place in the preset manner after identifying that the cover of the game prop withdrawing device is open, and recognize whether the mark part is not detected within the game area after identifying that the cover of the game prop withdrawing device is closed.

In some examples, the mark part is placed in the preset manner, for example, may be placed at a designated side outside the game prop withdrawing device. For example, the mark part may be expected to be placed at the left side or right side of the game prop withdrawing device, or at a side close to a surface with a logo, which may be set flexibly according to actual scenarios.

It may determine the state of the designated object based on a current collected image or video frame. However, since the game host has to take some time to complete operations on the game prop withdrawing device rather than instantaneously, the collected frames of the game area may include some frames corresponding to those moments when the game host is operating the game prop withdrawing device, for example, the game host is opening the cover, closing the cover, or taking out or putting in the mark part. In this case, the status of the designated object, for example, the game prop withdrawing device and the mark part, cannot be stably detected only based on the current frame and the identified state is not accurate, too. In some examples, in order to accurately determine the state of the designated object and obtain an accurate detection result, successive frames may be used to determine the state of the designated object. For example, when the state of the designated object is determined based on the images or videos of the game area, one or more target frames by which the state of the designated object can be stably detected may be firstly determined from the images or videos. In particular, in response to determining that the designated object in a certain collected frame has the first feature, whether the first feature changes in a next frame is recognized. If the answer is yes, a first counter is cleared; otherwise, the first counter is incremented by 1. When determining that a value of the first counter reaches a first counting threshold, it is determined that the designated object is in the first state. Similarly, in response to determining that the designated object in a certain collected frame has the second feature, whether the second feature changes in a next frame is recognized. If the answer is yes, a second counter is cleared; otherwise, the second counter is incremented by 1. When determining that a value of the second counter reaches a second counting threshold, it is determined that the designated object is in the second state.

By determining that the states of the designated object in successive frames are consistent, it is determined that the game host already completes the operations on the designated object, and the designated object is already in a stable state at this time. Further, it may be determined in combination with a coverage ratio of an operating component with respect to all or a part of the designated object, where the operating component is configured to operate the designated object. When the coverage ratio is less than a preset threshold, it is determined that the operating component has already completed its operations on the designated object at this time, that is, the operating component has already separated from the designated object. Therefore, it is further determined that the designated object with the first feature is in the first state, or the designated object with the second feature is in the second state. By simultaneously or sequentially detecting whether both the condition about the successive frames and the condition about the coverage ratio are satisfied, the accuracy of the determined state detection result of the designated object can be improved.

The operating component may be a human hand or may be another device for clamping or fixing the game prop withdrawing device, for example, a cover-opening or cover-closing device for the game prop withdrawing device and the like.

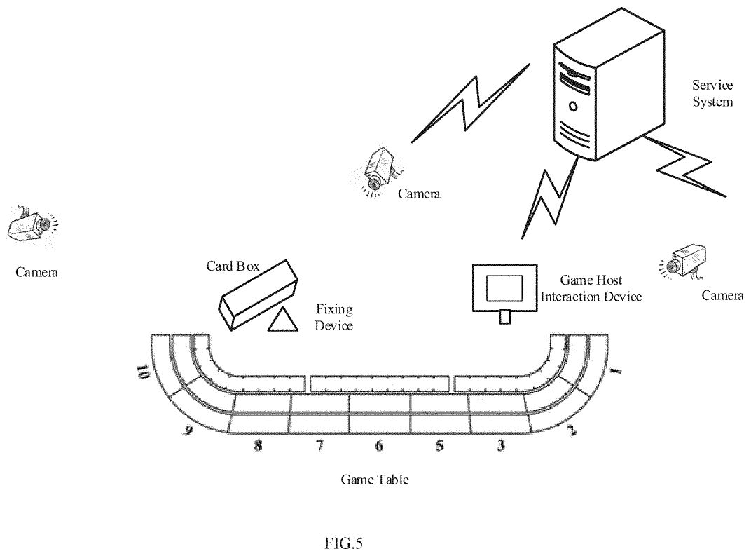

In some examples, as illustrated in FIG. 4, for determining the coverage ratio of the operating component with respect to the designated object, a first detection box 41 corresponding to all or the part of the designated object and a second detection box 42 corresponding to the operating component are determined in the collected frame based on a preset target detection algorithm, and then the coverage ratio of the operating component with respect to all or the part of the designated object is determined according to the coverage ratio of the second detection box 42 with respect to the first detection box 41.

The operations performed by the game host on the designated object include the operations on the cover of the game prop withdrawing device and the operations on the mark part. For example, it has to open the cover and take out the mark part from the game prop withdrawing device before adding the game props, and has to place the mark part into the game prop withdrawing device for fixing the game props and close the cover after adding the game props. In order to ensure that the game host already completes the operations on the designated object, it should be guaranteed that the operations on the cover and the mark part have been completed, that is, the cover and the mark part are both separated from the operating component. Therefore, in some examples, the cover ratio of the operating component with respect to the part of the designated object being smaller than the preset threshold may include the coverage ratio of the operating component with respect to the cover being smaller the preset threshold, the coverage ratio of the operating component with respect to the mark part being smaller than the preset threshold, and/or the coverage ratio of the operating component with respect to a combination of the cover and the mark part being smaller than the preset threshold. In this way, it is guaranteed that the game host already completes the operations on the cover and the mark part. At this time, the two statuses are both stable.

Of course, the service system determines whether the game enters the specific scenario in which the game host adds the game props into the game prop withdrawing device and performs operations of stopping or resuming the detection for the game area based on whether the specific scenario occurs, which is unperceivable to the game host at this time. In some examples, it is allowed to inform the game host simultaneously that the service system already identifies that the game enters the specific scenario and perform corresponding setting for the detection state parameter, so as to further supervise whether the service system makes a wrong determination. For this purpose, the service system may record first time information in response to determining for a first time that the designated object is in the first state, and record second time information in response to determining that the designated object is switched from the first state to the second state, and then send the first time information and the second time information to the game host for prompt attention. In this case, the game host can be informed whether the service system already identifies, at this time, that the game enters the specific scenario in which the game host adds the game props, and can further determine whether the service system makes a wrong determination according to actual progress of the game, thus ensuring the game proceeds in order.

Of course, a warning mechanism may be configured. That is, in response to detecting that the designated object meets a preset warning condition, a warning message is sent. For example, the operations by the game host, opening the cover of the game prop withdrawing device and adding the game props into the game prop withdrawing device, may usually be completed in a certain time length. Thus, in some examples, if it is detected based on the images or videos of the game area that the time length for which the cover of the game prop withdrawing device is open is greater than a first preset time length, it may mean that the game host forgets to close the cover or there is any another abnormality. Therefore, a first warning message is sent out to prompt the game host, so that the game host can find the abnormality in time. The first preset time length may be determined according to a time length that the game host takes to add the game props into the game prop withdrawing device.

For another example, in the game process, there may also be a scenario in which the game host opens the cover of the game prop withdrawing device, takes out the mark part, adds the game props into the game prop withdrawing device, but then directly closes the cover without placing the mark part into the game prop withdrawing device to fix the game props. In order to identify the abnormality, in some examples, when it is detected based on the images or videos of the game area that the mark part is still placed outside the game prop withdrawing device after the cover of the game prop withdrawing device is switched from open to close, a second warning message will be sent out to prompt the game host.

For another example, in the game process, there may also be a scenario in which the game host opens the cover of the game prop withdrawing device but forgets to take out the mark part from the game prop withdrawing device. In order to identify the abnormality, in some examples, when it is detected that a time length for which the cover of the game prop withdrawing device is open is greater than a second preset time length and the mark part is not detected outside the game prop withdrawing device, a third warning message will be sent out.

In some scenarios, a game host interaction device may be disposed in or near the game area, the warning information may be sent out through the game host interaction device. For example, a voice prompt may be output through the game host interaction device to prompt the game host about an abnormality, or a text or image prompt may be output through an interaction interface on the game host interaction device to prompt the game host about an abnormality. Of course, the voice prompt and the image prompt may be output at the same time. With the voice or image prompt, the game host may find any abnormal operation existing in the game process in time and perform corresponding processing, so as to ensure the game proceeds in order.

In some examples, the stages of the game within the game area may include a game prop operation pre-stage, a game prop operation stage, a game result processing stage, and the like. When the game is in the game prop operation pre-stage, a player may estimate a game result, for example, the player may estimate a win or lose result of each player in the game and bet with a token. When the game is in the game prop operation stage, the game host may operate the game props, for example, deal or flop cards. When the game is in the game result processing stage, the game host may determine the game result based on a situation of the game props within the game area, for example, calculate a score of each player based on the situation of cards within the game area to determine a win or lose result of the game and the like. The operation of adding the game props into the game prop withdrawing device is generally performed in the game prop operation pre-stage, so that the game props can be taken out from the game prop withdrawing device and operated correspondingly when the game enters the game prop operation stage. Therefore, in some examples, the target stage includes the game prop operation pre-stage. When it is determined that the game within the game area is in the target stage, the number of the game props within the game area may be determined based on the image or video frames of the game area. When the number of the game props within the game area is 0, it is determined that no operation has been performed on the game props at this time, that is, the game is in the game prop operation pre-stage.

In order to further explain the game monitoring method in the examples of the present disclosure, the explanation will be made below with a specific example.

Computer vision technology has already been widely applied to intelligent game halls. Images of a game hall or a game table are collected by one or more cameras and the on-going game on the game table is monitored and analyzed based on the images, so as to automatically identify any non-compliant action on the game table and automatically calculate a payout result of each round of game. In this way, the actions on the game table will be more compliant, the game will be more intelligent, and thus the game result will be fairer and more reliable.

Baccarat game is a common card game in the game hall. The Baccarat game involves four roles: Bank, Play. Tie and Pair. A player may choose any one of Banker. Player, Tie and Pair according to his own idea and put in game coins. After the player puts in the game coins, a dealer will draw 4-6 cards from 3-8 packs of shuffled cards. Then, the dealer will compare a sum of two cards of a Player and a sum of two cards of a Banker to determine which sum is more approximate to 9, or determine whether the Banker or the Player has a Pair or whether their points are equal. And then, the payout result of each player can be calculated according to the points of the cards and how much of the game coins the player put in.

FIG. 5 is a schematic diagram illustrating the Baccarat game in a game hall, in which cameras are disposed above and at both sides of the game table respectively to monitor what is going on the game table. Image or video data collected by the cameras will be sent out to a service system of the game hall. The service system may analyze a current stage of the game based on the image or video data, and perform a detection logic corresponding to the stage. In the service system, the Baccarat game is divided into five stages, i.e., idle, betting, gaming, payout, and halt. In different stages of the game, the service system will invoke different detection logics to detect the game area. After the game is switched from the idle stage to the betting stage through a game host interaction device on the game table (that is, to trigger the beginning of the game), the service system will determine a current stage of the game based on the image or video data collected by the cameras, and automatically complete switching between the stages and perform a detection logic corresponding to the stage. A game host interaction device is disposed near the game table, so that a game host may interact with the service system through the game host interaction device, for example, switch between stages of the game. In response to monitoring an abnormality of the game, the service system will also send out a warning message through the game host interaction device.

Generally, a shoebox (a card-pulling device) is placed on the game table to house cards to be dispensed. Usually, the shoebox has a fixing device (roller) to fix the cards in the shoebox. In the gaming stage, the dealer may draw the cards from the shoebox and dispense them to the Banker or the Player. During the game process, when there is no card in the shoebox, the dealer will open a cover of the shoebox, take out the fixing device from the shoebox, and place a pile of new cards into the shoebox according to a game rule. After the cards are placed into the shoebox, the fixing device will be placed back into the shoebox to fix the cards. During this process, the service system has to stop the detection for the game area, so as to avoid frequent error alarms caused by continuing monitoring the game area based on the original detection logic. In order to automatically identify the process in which the dealer adds cards into the shoebox and stop the detection for the game area in response to the process, the following way may be adopted.

Firstly, the service system may determine a current stage of the game based on the image or video data collected by the cameras. If no cards are found on the game table, it is determined that the game is in the betting stage. Because the operation of adding cards into the shoebox is usually performed in the betting stage, when it is found the game is in the betting stage, the state of the shoebox on the game table may be detected. If it is detected that the cover of the shoebox is open and the fixing device is placed at a side of the shoebox in a preset manner, it is determined that it is in a state in which the game host adds cards into the shoebox. Thus, at this time, the detection for the game area performed based on a detection logic corresponding to the betting stage may be stopped. When it is detected that the cover of the shoebox is switched from open to close and the fixing device is not detected on the game table, the detection for the game area may be resumed.

Of course, in order to make the state detection results of the shoebox and the fixing device as accurate as possible, when it is detected that the states of the shoebox and the fixing device in a plurality of successive frames are consistent and the cover of the shoebox and the fixing device are both separated from a human hand (i.e., two coverage ratios are both smaller than a preset threshold), the state of the shoebox may be recognized to ensure accurate detection results.

Furthermore, when it is detected the time length for which the cover of the shoebox is open is greater than a preset time length, a first warning message may be sent out through the game host interaction device; or, when it is detected that the cover of the shoebox is switched from open to close and the fixing device is placed on the game table, a second warning information may be sent out through the game host interaction device; or, when it is detected that the cover of the shoebox is open for a time length but the fixing device is not detected, a third warning information will be sent out through the game host interaction device. In this way, the game host may find the above abnormality in time.

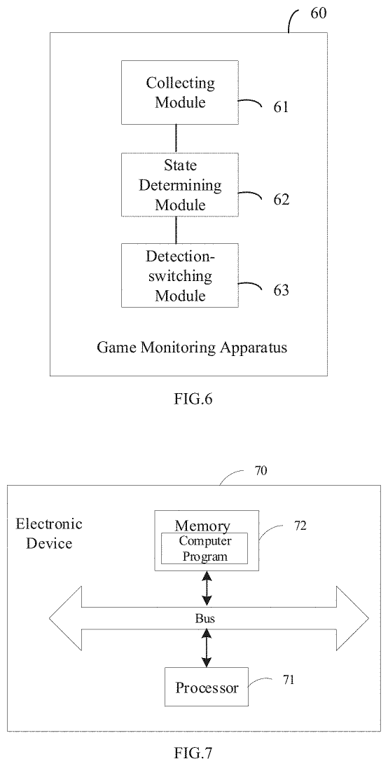

Corresponding to the above method, the examples of the present disclosure further provide a game monitoring apparatus. As illustrated in FIG. 6, the apparatus 60 includes:

a collecting module 61, configured to perform an image or video collection for a game area;

a state determining module 62, configured to determine a state of a designated object within the game area based on at least one collected frame; and

a detection-switching module 63, configured to stop a detection for the game area in response to determining that the designated object is in a first state, and resume the detection for the game area in response to determining that the designated object is switched from the first state to a second state.

In some examples, the state determining module 62 is configured to recognize whether the designated object has a first feature based on the at least one collected frame, and if yes, determine that the designated object is in the first state. The state determining module 62 is also configured to recognize whether the designated object has a second feature based on the at least one collected frame, and if yes, determine that the designated object is in the second state.

In some examples, the at least one collected frame includes a plurality of collected frames. The state determining module 62 is configured to determine the state of the designated object based on the plurality of collected frame. In particular, the state determining module 62 is configured to in response to determining that the designated object in a certain collected frame has the first feature, recognize whether the first feature changes in a next frame, and if yes, clear a first counter, otherwise increment the first counter by 1; and in response to determining that a value of the first counter reaches a first counting threshold, determine that the designated object is in the first state. The state determining module 62 is also configured to in response to determining that the designated object in a certain collected frame has the second feature, recognize whether the second feature changes in a next frame, and if yes, clear a second counter, otherwise increment the second counter by 1; and in response to determining that a value of the second counter reaches a second counting threshold, determine that the designated object is in the second state.

In some examples, the state determining module 62 is further configured to determine a coverage ratio of an operating component with respect to all or a part of the designated object, where the operating component is configured to operate the designated object; and in response to determining that the coverage ratio is less than a preset threshold, determine that the designated object with the first feature is in the first state, or the designated object with the second feature is in the second state.

In some examples, when determining the coverage ratio of the operating component with respect to all or the part of the designated object, the state determining module 62 is configured to determine a first detection box corresponding to all or the part of the designated object; determine a second detection box corresponding to the operating component; and determine the coverage ratio of the operating component with respect to all or the part of the designated object based on a coverage ratio of the second detection box with respect to the first detection box.

In some examples, the designated object includes at least a game prop withdrawing device. The first feature includes that a cover of the game prop withdrawing device is open. The second feature includes that the cover of the game prop withdrawing device is closed.

In some examples, the designated object further includes a mark part for fixing game props in the game prop withdrawing device. The first feature further includes that the mark part is placed in a preset manner. The second feature further includes that the mark part is not detected within the game area.

In some examples, the state determining module 62 may recognize the game prop withdrawing device and the mark part synchronously. Alternatively, the state determining module 62 may recognize the mark part in response to a recognition result of the game prop withdrawing device.

In some examples, the preset manner includes that the mark part is placed a designated side outside the game prop withdrawing device.

In some examples, the coverage ratio of the operating component with respect to the part of the designated object may include a coverage ratio of the operating component with respect to the game prop withdrawing device (or its cover), a coverage ratio of the operating component with respect to the mark part, or a coverage ratio of the operating component with respect to a combination of the game prop withdrawing device (or its cover) and the mark part.

In some examples, the game monitoring apparatus 60 is further configured to in response to determining for a first time that the designated object is in the first state, record and/or prompt corresponding first time information. The game monitoring apparatus 60 is further configured to in response to determining that the designated object is switched from the first state to the second state, record and/or prompt corresponding second time information.

In some examples, the game monitoring apparatus 60 is further configured to in response to determining that a game enters a target stage, determine the state of the designated object based on the at least one collected frame.

In some examples, the game monitoring apparatus 60 is further configured to in response to detecting that a number of game props within the game area is 0, determine that the game enters the target stage.

In some examples, the game monitoring apparatus 60 is further configured to in response to detecting that the designated object meets a preset warning condition, send out a warning message.

For example, in response to detecting that a time length for which the cover of the game prop withdrawing device is open is greater than a first preset time length, a first warning message is sent out.

For example, in response to detecting that the mark part is still placed outside the game prop withdrawing device after the cover of the game prop withdrawing device is switched from open to close, a second warning message is sent out.

For example, in response to detecting that a time length for which the cover of the game prop withdrawing device is open is greater than a second preset time length and the mark part is not detected outside the game prop withdrawing device, a third warning message is sent out.

In some embodiments, the game includes a card game, and the game prop withdrawing device includes a card box.

Further, the examples of the present disclosure further provide an electronic device. As illustrated in FIG. 7, the electronic device includes a processor 71, a memory 72, and computer programs stored in the memory 72 for execution by the processor 71. The computer programs are executed by the processor 71 to implement the method according to any one of the above examples.

The examples of the present disclosure further provide a computer-readable storage medium storing computer programs thereon. The computer programs are executed by a processor to implement the method according to any one of the above examples.

The computer-readable storage medium includes permanent or non-permanent, mobile or non-mobile media, which can realize information storage by any method or technology. The information may be computer-readable instructions, data structures, program blocks and other data. The examples of the computer-readable storage medium include but not limited to: a Phasechange Random Access Memory (PRAM), a Static Random Access Memory (SRAM), a Dynamic Random Access Memory (DRAM), or an RAM of another type, a Read-Only Memory (ROM), an Electrically-Erasable Programmable Read-Only Memory (EEPROM), a Flash Memory, or another memory technology, a CD-ROM, a digital versatile disc (DVD), or another optical storage, cassette type magnetic tape, magnetic disk storage, or another magnetic storage device, or another non-transmission medium, for storing information accessible by computing devices. According to the definition of the specification, the computer-readable medium does not include transitory computer-readable media, for example, modulated data signal and carriers.

It may be known from descriptions of the above implementations that persons skilled in the art may clearly understand that the examples of the present disclosure may be implemented by means of software and a necessary general hardware platform. Based on such understanding, the technical solutions of the examples of the present disclosure essentially or a part contributing to the prior art may be embodied in the form of a software product, and the computer software product may be stored in a storage medium, such as a ROM/RAM, a diskette or a compact disk, and includes several instructions for enabling a computer device (such as a personal computer, a server or a network device) to perform the methods of various examples or some parts of the examples of the present disclosure.

The systems, methods, modules or units described in the above examples may be specifically implemented by a computer chip or an entity, or may be implemented by a product with a particular function. A typical implementing device may be a computer, and the computer may specifically be a personal computer, a laptop computer, a cellular phone, a camera phone, a smart phone, a personal digital assistant, a media player, a navigation device, an email transceiver, a game console, a tablet computer, a wearable device, or a combination of any several devices of the above devices.

The examples in the present disclosure are described in a progressive manner, each example focuses on differences from other examples, and same or similar parts among the examples may be referred to each other. Especially, since apparatus examples are basically similar to method examples, simple descriptions are made to the apparatus examples, and relevant parts may be referred to the descriptions of the method examples. The apparatus examples described above are merely illustrative, where modules described as separate members may be or not be physically separated, and functions of different modules may be implemented in the same or several software and/or hardware during implementing the examples of the present disclosure. Part or all of the modules may also be selected according to actual requirements to achieve the objectives of the solution of the example. Persons of ordinary skill in the art may understand and implement the solutions without creative work. The above descriptions are merely specific examples of the present disclosure. It is to be noted that persons of ordinary skill in the art may also make several improvements and modifications without departing from the principles of the examples of the present disclosure, and these improvements and modifications shall also be included in the scope of protection of the present disclosure.

1. A game monitoring method, comprising:
performing an image or video collection for a game area;
determining a state of a designated object within the game area based on at least one collected frame;
in response to determining that the designated object is in a first state, stopping a detection for the game area; and
in response to determining that the designated object is switched from the first state to a second state, resuming the detection for the game area.

2. The method according to claim 1, wherein the determining the state of the designated object within the game area based on the at least one collected frame comprises:
recognizing whether the designated object has a first feature based on the at least one collected frame, and if yes, determining that the designated object is in the first state; or
recognizing whether the designated object has a second feature based on the at least one collected frame, and if yes, determining that the designated object is in the second state.

3. The method according to claim 2, wherein the at least one collected frame comprises a plurality of collected frames:
wherein the determining the state of the designated object based on the at least one collected frame comprises:
in response to determining that the designated object in a certain collected frame has the first feature, recognizing whether the first feature changes in a next frame, and if yes, clearing a first counter, otherwise incrementing the first counter by 1; and
in response to determining that a value of the first counter reaches a first counting threshold, determining that the designated object is in the first state:
or,
in response to determining that the designated object in a certain collected frame has the second feature, recognizing whether the second feature changes in a next frame, and if yes, clearing a second counter, otherwise incrementing the second counter by 1; and
in response to determining that a value of the second counter reaches a second counting threshold, determining that the designated object is in the second state.

4. The method according to claim 2, further comprising:
determining a coverage ratio of an operating component with respect to all or a part of the designated object, wherein the operating component is configured to operate the designated object; and
in response to determining that the coverage ratio is less than a preset threshold, determining that the designated object with the first feature is in the first state, or the designated object with the second feature is in the second state.

5. The method according to claim 4, wherein the determining the coverage ratio of the operating component with respect to all or the part of the designated object comprises:
determining a first detection box corresponding to all or the part of the designated object;
determining a second detection box corresponding to the operating component; and
determining the coverage ratio of the operating component with respect to all or the part of the designated object based on a coverage ratio of the second detection box with respect to the first detection box.

6. The method according to claim 4, wherein the determining the coverage ratio of the operating component with respect to the part of the designated object comprises:
determining a coverage ratio of the operating component with respect to a cover of a game prop withdrawing device.

7. The method according to claim 2, wherein the designated object comprises at least a game prop withdrawing device:
wherein the first feature comprises that: a cover of the game prop withdrawing device is open; or
wherein the second feature comprises that: the cover of the game prop withdrawing device is closed.

8. The method according to claim 7, wherein the designated object further comprises a mark part for fixing game props in the game prop withdrawing device;
wherein the first feature further comprises that: the mark part is placed in a preset manner; or
wherein the second feature further comprises that: the mark part is not detected within the game area.

9. The method according to claim 8,
wherein the recognizing whether the designated object has the first feature comprises:
in response to recognizing that the cover of the game prop withdrawing device is open, recognizing whether the mark part is placed in the preset manner; or
wherein the recognizing whether the designated object has the second feature comprises:
in response to recognizing that the cover of the game prop withdrawing device is closed, recognizing whether the mark part is not detected within the game area.

10. The method according to claim 8, wherein the preset manner comprises that:
the mark part is placed a designated side outside the game prop withdrawing device.

11. The method according to claim 1, further comprising:
in response to determining for a first time that the designated object is in the first state, recording and/or prompting corresponding first time information; or
in response to determining that the designated object is switched from the first state to the second state, recording and/or prompting corresponding second time information.

12. The method according to claim 1, further comprising:
in response to determining that a game enters a target stage, determining the state of the designated object based on the at least one collected frame.

13. The method according to claim 12, further comprising:
in response to detecting that a number of game props within the game area is 0, determining that the game enters the target stage.

14. The method according to claim 1, further comprising:
in response to detecting that the designated object meets a preset warning condition, sending out a warning message.

15. An electronic device, comprising:
at least one processor; and
one or more memories coupled to the at least one processor and storing programming instructions for execution by the at least one processor to perform operations comprising:
performing an image or video collection for a game area;
determining a state of a designated object within the game area based on at least one collected frame;
in response to determining that the designated object is in a first state, stopping a detection for the game area; and
in response to determining that the designated object is switched from the first state to a second state, resuming the detection for the game area.

16. The electronic device according to claim 15, wherein the determining the state of the designated object within the game area based on the at least one collected frame comprises:
recognizing whether the designated object has a first feature based on the at least one collected frame, and if yes, determining that the designated object is in the first state; or
recognizing whether the designated object has a second feature based on the at least one collected frame, and if yes, determining that the designated object is in the second state.

17. The electronic device according to claim 16, wherein the operations further comprises:
determining a coverage ratio of an operating component with respect to all or a part of the designated object, wherein the operating component is configured to operate the designated object; and
in response to determining that the coverage ratio is less than a preset threshold, determining that the designated object with the first feature is in the first state, or the designated object with the second feature is in the second state.

18. The electronic device according to claim 16, wherein the designated object comprises at least a game prop withdrawing device;
wherein the first feature comprises that: a cover of the game prop withdrawing device is open; or
wherein the second feature comprises that: the cover of the game prop withdrawing device is closed.

19. The electronic device according to claim 18, wherein the designated object further comprises a mark part for fixing game props in the game prop withdrawing device;
wherein the first feature further comprises that: the mark part is placed in a preset manner; or
wherein the second feature further comprises that: the mark part is not detected within the game area.

20. A non-transitory computer-readable storage medium coupled to at least one processor and storing programming instructions for execution by the at least one processor to:
perform an image or video collection for a game area;
determine a state of a designated object within the game area based on at least one collected frame;
in response to determining that the designated object is in a first state, stop a detection for the game area; and
in response to determining that the designated object is switched from the first state to a second state, resume the detection for the game area.
